(19) United States
(12) Patent Application Publication
(10) Pub. No.: US 2015/0259220 A1
(43) Pub. Date: Sep. 17, 2015

(54) Liquid Vaporization Systems and Methods of Use

(71) Applicant: ADVANCED OXIDATION REDUCTION TECHNOLOGIES, LLC, Westminster, CO (US)

(72) Inventors: Louis Rosocha, Los Alamos, NM (US); Lowell Morgan, Monument, CO (US); George Kast, Westminster, CO (US)

(21) Appl. No.: 14/433,548

(22) PCT Filed: Oct. 4, 2013
(86) PCT No.: PCT/US2013/063457

§ 371 Date: Apr. 3, 2015

Related U.S. Application Data
(60) Provisional application No. 61/709,913, filed on Oct. 4, 2012.

(51) Int. Cl. C02F 1/04; B01D 1/00

(52) U.S. Cl. CPC C02F 1/048; B01D 1/0023; C02F 2101/322

(57) ABSTRACT

A liquid vaporization system according to the present invention includes the application of energy, including pulsed electrical discharges, sparks or continuous arcs, to or within a spray comprising a liquid that may be combined with a flammable compound. The liquid is typically water or other aqueous composition o flowable solutions, and the flammable compound is typically, but not necessarily, a flammable gas. The spray generated by a nozzle typically comprises finite size droplets. The finite size droplets typically have a size distribution, and droplet size is generally expressed as drop diameter in units of 10⁻⁶ meters (μm).

This application is being filed on 4 Oct. 2013, as a PCT International patent application, and claims priority to U.S. Provisional Patent Application No. 61/709,913, the disclosure of which is hereby incorporated by reference herein in its entirety.

### INTRODUCTION

Oil and gas production operations are facing increasingly complex water management issues including the proper treatment and/or disposal of produced and flowback water. In many areas, disposal well capacities and locations may not be able to keep pace with the new production wells and rising water volumes. Treating and/or disposing of produce and flowback water is an expensive, complex and energy intensive process.

For example, evaporation of liquid can be energy intensive. This is particularly true where large quantities of water must be evaporated over a relatively short time interval, and where evaporation ponds are impractical. Distillation of water, for example, for desalination or other water purification purposes, can also require large quantities of energy. Accordingly, an energy efficient and less expensive means of liquid vaporization as an alternative treatment and/or disposal of produced, flowback and other types of water is necessary.

### BRIEF DESCRIPTION OF THE DRAWINGS

Referring to the drawings, wherein like numerals represent like parts throughout the several views.

FIG. 1 illustrates an embodiment of the liquid vaporization system presently disclosed comprising a flowable solution, a pressure source, a nozzle and an igniter.

FIG. 2 illustrates an embodiment of the liquid vaporization system presently disclosed comprising all the components of FIG. 1 with an optional vaporization chamber.

FIG. 3 illustrates an embodiment of the liquid vaporization system presently disclosed comprising all the components of FIG. 2 with an optional second igniter, an optional second vaporization chamber, and an optional particulate capture.

FIG. 4 illustrates an embodiment of the liquid vaporization system presently disclosed comprising all the components of FIG. 2 with an optional addition of one or more additives at or upstream of the nozzle.

FIG. 5 illustrates an embodiment of a method of using the liquid vaporization system presently disclosed comprising pressurization of the flowable solution, first stage vaporization, an optional second stage vaporization and an optional post vaporization treatment.

FIG. 6 illustrates an embodiment of a method of using the liquid vaporization system presently disclosed comprising pressurization of the flowable solution, first stage vaporization that includes an optional vaporization chamber, an optional second stage vaporization that includes ignition and an optional vaporization chamber, and an optional post vaporization treatment.

FIG. 7 illustrates the flammability limits for methane/air/water mixtures.

FIG. 8 illustrates the burning velocity as a function of initial water loading and droplet size.

FIG. 9 illustrates the water mass fraction for a given drop diameter needed to reduce the burn velocity by 20%.

FIG. 10 illustrates a side profile of a nozzle and an igniter embodiment of the liquid vaporization system presently disclosed.

FIG. 11A illustrates a side profile of a nozzle and an igniter embodiment in use of the liquid vaporization system presently disclosed.

FIG. 11B illustrates a side profile of a nozzle and an igniter embodiment in use of the liquid vaporization system presently disclosed.

FIG. 11C illustrates a side profile of a nozzle and an igniter embodiment in use of the liquid vaporization system presently disclosed.

FIG. 11D illustrates a side profile of a nozzle and an igniter embodiment in use of the liquid vaporization system presently disclosed.

FIG. 11E illustrates a side profile of a nozzle and an igniter embodiment in use of the liquid vaporization system presently disclosed.

FIG. 12 illustrates oscilloscope traces of operating electric discharge for the nozzle and igniter embodiment of the liquid vaporization system disclosed in FIG. 11.

FIG. 13 illustrates a side profile of a nozzle and an igniter embodiment of the liquid vaporization system presently disclosed.

FIG. 14 illustrates a side profile of a nozzle and an igniter embodiment of the liquid vaporization system presently disclosed.

FIG. 15A illustrates a side profile of a nozzle and an igniter embodiment (multi-electrode glid-arc igniter) of the liquid vaporization system presently disclosed.

FIG. 15B illustrates a top profile of a nozzle and an igniter embodiment (multi-electrode glid-arc igniter) of the liquid vaporization system presently disclosed and referred to in FIG. 15A.

FIG. 16A illustrates a top profile of a igniter embodiment (cavetron-plasmatron 3-D glid-arc) of the liquid vaporization system presently disclosed.

FIG. 16B illustrates a side profile of a igniter embodiment (cavetron-plasmatron 3-D glid-arc) of the liquid vaporization system presently disclosed and referred to in FIG. 16A.

FIG. 16C illustrates another side profile (rotated 90 degrees from FIG. 16B) of a igniter embodiment (cavetron-plasmatron 3-D glid-arc) of the liquid vaporization system presently disclosed and referred to in FIG. 16A and FIG. 16B.

FIG. 17A illustrates a side profile of an embodiment of a nozzle operatively connected to an igniter of the liquid vaporization system presently disclosed.

FIG. 17B illustrates a side profile (45 degrees rotation from FIG. 17A) of an embodiment of a nozzle operatively connected to an igniter of the liquid vaporization system presently disclosed.

FIG. 17C illustrates a top profile of an embodiment of a nozzle operatively connected to an igniter of the liquid vaporization system presently disclosed and referred to in FIG. 17A and FIG. 17B.

FIG. 18A illustrates a side profile of an igniter embodiment (graphite cavitron 3-D glid-arc plasma reactor) of the liquid vaporization system presently disclosed.

FIG. 18B illustrates a top profile and a side profile (rotated 90 degrees from FIG. 18A) of an igniter embodiment (graphite cavitron 3-D glid-arc plasma reactor) of the liquid vaporization system presently disclosed and referred to in FIG. 18A.

FIG. 19 illustrates an embodiment of multiple nozzles operatively connected to multiple igniters (modular cavitron chessboard) of the liquid vaporization system presently disclosed.

FIG. 20A illustrates a top view of an igniter embodiment, nozzle embodiment and vaporization chamber embodiment of the present disclosure. In this embodiment, the igniter is similar to a rail plug (see, e.g., U.S. Pat. No. 5,076,223).

FIG. 20B illustrates a side view of an igniter embodiment, nozzle embodiment and vaporization chamber embodiment of the present disclosure. In this embodiment, the igniter is similar to a rail plug (see, e.g., U.S. Pat. No. 5,076,223).

### DEFINITIONS AND TERMINOLOGY

The terms and phrases as indicated in quotation marks (“ ”) in this section are intended to have the meaning ascribed to them in this section applied to them throughout this document, including in the claims, unless clearly indicated otherwise in context. Further, as applicable, the stated definitions are to apply, regardless of the word or phrase's case, to the singular and plural variations of the defined word or phrase.

The term “or” as used in this specification and the appended claims is not meant to be exclusive; rather the term is inclusive, meaning either or both.

References in the specification to “one embodiment”, “an embodiment”, “another embodiment, “a preferred embodiment”, “an alternative embodiment”, “one variation”, “a variation” and similar phrases mean that a particular feature, structure, or characteristic described in connection with the embodiment or variation, is included in at least an embodiment or variation of the invention. The phrase “in one embodiment”, “in one variation” or similar phrases, as used in various places in the specification, are not necessarily meant to refer to the same embodiment or the same variation.

The term “couple” or “coupled” as used in this specification and appended claims refers to an indirect or direct physical connection between the identified elements, components, or objects. Often the manner of the coupling will be related specifically to the manner in which the two coupled elements interact.

The term “directly coupled” or “coupled directly,” as used in this specification and appended claims, refers to a physical connection between identified elements, components, or objects, in which no other element, component, or object resides between those identified as being directly coupled.

The term “approximately,” as used in this specification and appended claims, refers to plus or minus 10% of the value given.

The term “about,” as used in this specification and appended claims, refers to plus or minus 20% of the value given.

The terms “generally” and “substantially,” as used in this specification and appended claims, mean mostly, or for the most part.

The term “aqueous composition” or “flowable solution” as used in this specification and appended claims, refers to a solution, mixture, suspension, or emulsion comprising at least 10% by weight water.

The term “produced water” as used in this specification refers to waste water produced from oil and natural gas production operations. Produced water is typically contaminated with significant concentrations of chemicals and substances requiring that it be disposed of or treated before it can be reused or discharged to the environment. Produced water includes natural contaminants that come from the subsurface environment, such as hydrocarbons from the oil-or gas-bearing strata, heavy metals, and inorganic salts. Produced water may also include man-made contaminants resulting from well operations such as spent well stimulation chemicals, spent biocides used to prevent biological fouling of a well and other well treatment chemicals. For example, one type of produced water has the following contaminates:

| | | Units |
|---|---|---|
| General Parameters | | |
| Alkalinity as CaCO3 | 5000 | mg/L |
| Total Hardness as CaCO3 | 200 | mg/L |
| Major Ions | | |
| Ammonia | 15 | mg/L |
| Calcium | 120 | mg/L |
| Chloride | 5000 | mg/L |
| Fluoride | 15 | mg/L |
| Magnesium | 80 | mg/L |
| Nitrate | 3 | mg/L |
| Potassium | 25 | mg/L |
| Sodium | 5000 | mg/L |
| Sulfate | 15 | mg/L |
| Physical Properties | | |
| Conductivity | 14000 | uS/cm |
| pH | 8.5 | s.u. |
| Total Dissolved Solids (TDS) | 10000 | mg/L |
| Total Suspended Solids (TSS) | 500 | mg/L |
| Turbidity | 350 | NTU |
| Temerature | <100 | F. |
| Pressure | 20 | psi |
| TOC | 600 | mg/L |
| COD | 2400 | mg/L |
| BOD | 700 | mg/L |
| Total Metals | | |
| Slenium | <0.5 | ug/L |
| Iron | 4000 | ug/L |
| Barium | 20 | mg/L |
| Dissolved Metals | | |
| Aluminum | 400 | ug/L |
| Arsenic | <2.5 | ug/L |
| Beryllium | <1 | ug/L |
| Boron | 30000 | ug/L |
| Cadmium | <0.08 | ug/L |
| Chromium | <0.5 | ug/L |
| Copper | 3.5 | ug/L |
| Iron | 250 | ug/L |
| Lead | 15 | ug/L |
| Manganese | 100 | ug/L |
| Mercury | <0.2 | ug/L |
| Nickel | <2.5 | ug/L |
| Silica | 200000 | ug/L |
| Silver | <0.5 | ug/L |
| Strontium | <0.5 | ug/L |
| Thallium | <0.1 | ug/L |
| Zinc | 2000 | ug/L |
| Hydocarbons | | |
| TPH | 50 | mg/L |
| Benzene | 75 | mg/L |
| Toluene | 150 | mg/L |
| Ethyl Benzene | 10 | mg/L |
| Xylene | 75 | mg/L |
| GRO | 1250 | mg/L |
| DRO | 375 | mg/L |
| Methanol | 300 | mg/L |

The term “flowback water” as used in this specification refers to wastewater from wells occurring as a result of the hydraulic fracturing process. A byproduct of the fracturing process is an aqueous stream similar to produced water except that it also includes spent fracturing chemicals. Flowback water includes spent fracturing fluids such as polymers and inorganic cross-linking agents, polymer breaking agents, friction reduction chemicals, and artificial lubricants. These contaminants are injected into the wells as part of the fracing process and recovered as contaminants.

The term “sustained flame,” as used in this specification and appended claims, refers to a flame that is continuous, or that is extinguished for less than 500 milliseconds (msec) out of every second (sec) for a specified time interval (<500 msec/sec). Variations of sustained flames are extinguished preferably for less than 100 msec/sec, more preferably for less than 10 msec/sec, and most preferably for less than 1 msec/sec, for a specified time interval. Specified time intervals are preferably at least 30 minutes, more preferably at least 10 minutes, still more preferably at least 1 minute, and most preferably at least 30 seconds.

The term “spark” or “sparks” as used in this specification and appended claims refers to actual spark(s) (individual events) and to arc(s) (continuous events).

### DETAILED DESCRIPTION

The present disclosure provides systems, devices and methods of use for vaporizing flowable solutions using an igniter to ignite the flowable solution after a nozzle converts the flowable solution to a spray. The systems, devices and methods of the present disclosure provide an efficient and cost effective way to dispose of produced water, or other flowable solution needing disposal, by converting the produced water to a spray comprising finite droplets via a nozzle and subjecting the droplets to an ignition source that ultimately controllably burns the flowable solution.

Embodiments of liquid vaporization systems according to the present invention include the application of an ignition source, including pulsed electrical discharges or sparks, to or within a spray comprising a first liquid that may be combined with a flammable compound. The first liquid is typically water or other aqueous composition or flowable solutions, and the flammable compound is typically, but not necessarily, a flammable gas. Examples of flammable gasses include, but are not limited to, hydrocarbons such as methane, ethane, propane, n-butane, and isobutane. The spray typically includes an oxidant. The oxidant is typically molecular oxygen (O₂). The first liquid of the spray typically comprises finite size droplets. The finite size droplets typically have a size distribution, and droplet size is generally expressed as drop diameter in units of 10⁻⁶ meters (μm).

Embodiments of the present invention differ from the prior art because, among other things, a controlled, sustained burn is maintained through continuous or repeated electrical discharge in a mixture of flammable gas, water and air. After passing through a nozzle, atomizer, venturi, or the like, which disperses the water into a spray of droplets having various sizes, the water is primarily in the form of a spray, mist, or aerosol, rather than water vapor or steam.

To aid in the understanding of the technology described herein, an alternative description of the system and method is as follows. The system is designed to treat a liquid that contains both oxidizable and non-oxidizable components. In an embodiment, the liquid is produced water that contains water and various contaminants such as salts, hydrocarbons, heavy metals, polymers, etc. (some of which are oxidizable and some of which may not be oxidizable). In the embodiment, the liquid is passed through a nozzle and the output of the nozzle is exposed to the igniter. The igniter causes at least some of the oxidizable components to oxidize, thereby releasing heat. Depending on the embodiment, the igniter may oxidize all the oxidizable components. Alternatively, the heat generated by the igniter's oxidation of some of the oxidizable components causes further oxidation of some or all of the remaining oxidizable components and also vaporizes the non-oxidizable components. In an embodiment, the vaporization chamber is designed in order to increase the efficiency of the system by increasing the residence time of the components to the heat generated by the oxidation after ignition. As sufficient oxygen is necessary for complete oxidation, supplemental oxygen may be added, for example in the form of air, oxygen or oxygen containing gas or liquid added before, during or after the ignition (e.g., into the vaporization chamber). Likewise, if the goal is complete vaporization of the non-oxidizable components, then supplemental fuel may be added, for example by introducing methane, natural gas, propane, acetylene, or other hydrocarbons before, during or after ignition (e.g., into the vaporization chamber).

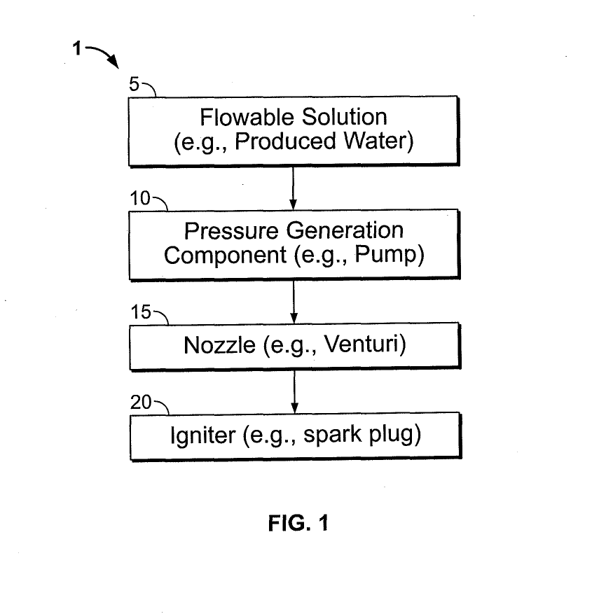

Referring now to FIG. 1, the present disclosure includes a liquid vaporization system comprising a pressure generation component 10, a nozzle 15 and an igniter 20. The liquid vaporization system may further comprise a flowable solution 5. In an embodiment, the pressure generation system moves the flowable solution 5 through a flowable solution line (not pictured) to the nozzle 15. The nozzle creates a spray (i.e., mist) from the flowable solution. The igniter 20 is placed proximate or adjacent to the nozzle so that the spray dispensing from the nozzle is in close proximity to the igniter 20.

In an embodiment, the igniter 20 is capable of igniting and/or burning the spray generated by the nozzle 15. The proximity of the igniter 20 to the nozzle 15 is such that the igniter is capable of igniting and/or burning spray without suffering from any negative effects of the spray. For example, the igniter 20 must be close enough to the spray to continuously ignite the flowable solution droplets before the droplets become too dispersed but not so close as to be blown out or overwhelmed by the pressure from the spray. The appropriate distance between the igniter 20 and the nozzle 15 will vary depending on several variables, including pressure of the flowable solution, the type of nozzle, the characteristic of the flowable solution (e.g., hydrocarbon content), the type of igniter 20 and whether any additional fuel source is mixed with the flowable solution either prior to the nozzle 15 or at the nozzle 15.

In an exemplary embodiment, a pump would generate pressure to move produced water from a holding tank or reservoir to a nozzle capable of atomizing the produced water. One or more spark plugs sit directly adjacent to the spray dispensing end of the nozzle and generate sparks at a rate of between 100 Hz and 100,000 Hz. The sparks ignite the spray resulting in the vaporization of the spray (including the produced water) upon burning.

The flowable solution 5 may be produced water or it may be any solution capable of pumping through a nozzle and for which a user has a need to dispose. For example, the flowable solution 5 may be produced water, flowback water, leach field water, grey water, brown water, tar sand, mine waste water, storm drain water, or some combination thereof.

Many of the flowable solutions 5 contemplated by the present disclosure include high hydrocarbon content and are therefore inherently flammable, or have a propensity to be flammable, in some situations. Disposal of flowable solutions containing high amounts of hydrocarbon, e.g., produced water, is costly and energy inefficient. The systems, devices and methods presently disclosed address the cost and energy inefficiency of current disposal techniques by providing a quick method to dispose of the flowable solutions through oxidation, reduction and/or degredation of the flowable solution and its components, hydrocarbons or otherwise.

While not directly disclosed in FIG. 1, the present disclosure contemplates a pretreatment component of the system or method for pretreating the flowable solution prior to pumping the flowable solution or prior to the flowable solution reaching the nozzle (upstream of the nozzle). The pretreatment component can include any alteration of the flowable solution, for example, an oil/water separator, a gravity pond, a produced water pit, a filter, a storage vessel, a dilution system or some combination thereof.

The pressure generation component 10 may be any pump, gravity or any other pumping or pressurization technique that is capable of moving the flowable solution to the nozzle. For example, the pressure generation component 10 may be a displacement pump, gravity pump, or some combination thereof.

The nozzle 15 is a nozzle capable of atomizing the flowable solution in some embodiments but many types of nozzles are suitable so long as the nozzle can generate a spray or mist as the flowable solution passes there through. Nozzles suitable for the present disclosure may include atomizing nozzles, mixing nozzles, cavitation nozzles, venturi nozzles, plasmatron nozzles, coanda nozzles or some combination thereof.

Embodiments include nozzles of such a size, typically but not necessarily having a nozzle orifice diameter in a range of 0.008″—1.0 inch, to create a mist having finite size droplets, rather than steam. Variations include a nozzle orifice about 0.015″ in diameter. The nozzle orifice diameter will vary depending on several factors, including but not limited to, the pressure the flowable solution enters the nozzle, the viscosity and properties of the flowable solution, the climate, the igniter source and the volume of flowable solution entering the nozzle every minute. The nozzle orifice diameter will be sized to achieve a desirable spray or mist consistency (e.g., finite droplets) based on a number of factors, i.e., specific flow rate, atomization (if desired), and shape of spray or mist.

The igniter 20 can be one or more spark plugs or any device capable of igniting the spray of flowable solution generated by the nozzle. In one embodiment, the igniter 20 is a one or more spark plugs that generate sparks at a rate of between 100 Hz and 100,000 Hz. In other embodiments the igniter 20 may be plasma torch, microwave, radio frequency powered electrode, electronic ignition system, dialectic barrier discharge system, heated filament, rail plug (see, e.g., U.S. Pat. No. 5,076,223) or some combination thereof.

Embodiments of the igniter 20 include pulsed electric discharge, which continuously re-ignites an air/flammable gas/water spray mixture even if water density is high enough to quench the flame. Embodiments include, but are not limited to, pulsed Direct Current (DC) discharges at frequencies near 800-900 Hz. The pulsed Direct Current (DC) discharge embodiments are simple to construct and, being pulsed, use less average power than a comparable continuous discharge.

The pulsed electric discharge may be described as an intermittent application of high voltage to water/gas mixtures sufficient to produce an electrical discharge-initiated plasma, which is typically pulsed Direct Current (DC). Variations can include Alternating Current (AC), microwave, or Radio Frequency (RF). A dielectric barrier discharge (DBD) includes one or more electrodes covered with a dielectric material. This allows the device to create a plasma via numerous streamers at atmospheric pressure, without sparking or arcing. It creates pulsed electrical discharges in a gas or gas/water-vapor. An electrical discharge occurs when a gas or gas-water mixture is sufficiently ionized to establish a high conductivity of electricity.

The igniter may be powered by any number of common power sources. For example and in addition to those already mentioned, 110 volt power supply, 220 volt power supply, 12 volt power supply, Alternating Current, Direct Current, fuel cells, solar power, high voltage power supply, switched mode power supply, or some combination thereof.

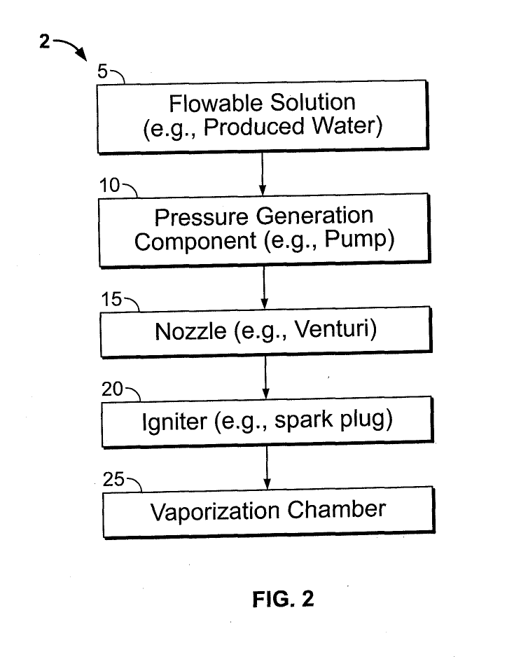

Referring now to FIG. 2, in some embodiments the liquid vaporization system may include a vaporization chamber 25. The vaporization chamber 25 can enclose, surround, or sit proximal or adjacent to the igniter 20. The vaporization chamber 25 can be integral with the igniter or a separate component from the igniter that is removable depending on the environment. In an embodiment, the vaporization chamber 25 provides sound dampening, e.g., in some instances through heat resistant insulation, that reduces the noise associated with the nozzle, igniter, and/or resulting flame. In some embodiments, the vaporization chamber 25 may also act as a heat shield and/or incubator. As a heat shield, the vaporization chamber 25 can reduce the amount of heat reaching users, equipment or the environment within close proximity to the liquid vaporization system. As an incubator, the vaporization chamber 25 acts like an oven to maintain the high temperatures generated by the ignition of mist and further foster and permit the oxidation, reduction and/or degradation of the flowable solution and its components, e.g., hydrocarbons. Specifically, the vaporization chamber 25 can increase the resonance time of the spray at high temperature.

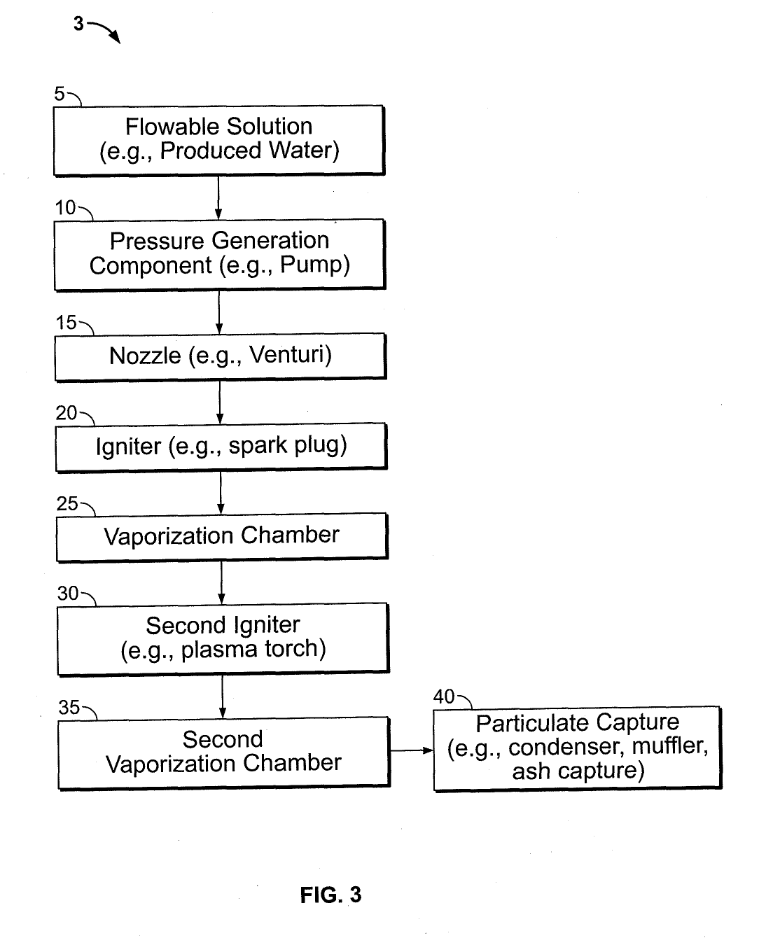

Referring now to FIG. 3, in some embodiments the liquid vaporization system may include a particulate capture component 40. The use of a particulate capture component 40 may happen without the use of a vaporization chambers 25, 35 and a second igniter 30 or it may occur as depicted in FIG. 3 with two vaporization chambers 25, 35 and a second igniter 30.

In the embodiment depicted in FIG. 3, the liquid vaporization system moves a flowable solution 5 through a flowable solution line (not shown) using a pressure generation component 10 to a nozzle 15. As previously described in reference to FIG. 1, the nozzle generates a mist comprising the flowable solution 5 that is ignited by the igniter 20. The optional first vaporization chamber 25 further facilitates the ignition and subsequent oxidation, reduction and/or degradation of the flowable solution and its components. In the embodiment disclosed in FIG. 3, the liquid vaporization system further comprises an optional second igniter 30, an optional second vaporization chamber 35 and an optional particulate capture component 40.

In an embodiment, the misted (e.g., finite droplets) of the flowable solution are subjected to the first igniter 20 which utilizes a first vaporization chamber 25. The mist, to the extent any mist or matter remains, is then subjected to a second igniter 30 which utilizes a second vaporization chamber 35. The second igniter 30 and second vaporization chamber 35 can be replications of the first igniter 20 and the first vaporization chamber 25. However, in some embodiments, the second igniter and/or second vaporization chamber are different than the first igniter 20 and first vaporization chamber 25. In an exemplary embodiment, the second igniter generates higher reaction temperatures by using an ignition source in combination with a second vaporization chamber 35 to reach higher sustained temperatures.

The second igniter 30 can be one or more spark plugs or any device capable of igniting the spray of flowable solution generated by the nozzle. For example, the second igniter 30 may be plasma torch, microwave, radio frequency powered electrode, electronic ignition system, dialectic barrier discharge system, heated filament, rail plug (see, e.g., U.S. Pat. No. 5,076,223) or some combination thereof. Like the first vaporization chamber 25, the second vaporization chamber 35 can take on all the embodiment previously described for the first vaporization chamber 25, including that is can enclose, surround, or sit proximal or adjacent to the second igniter 30.

In some embodiments, the pulsed electric discharge or spark mediated vaporization process of the first igniter 20 is followed by a second igniter 30 including a dielectric barrier, microwave, or Radio Frequency (RF) discharge plasma to superheat the water vapor and other substances in the spray. The second igniter can be referred to as an afterburner. A plasma is typically created, wherein organic molecules and other substances are dissociated and destroyed. The plasma can achieve temperatures as high as 5000° C.-7000° C. in the second stage, which is hot enough to dissociate many organic molecules. As the plasma cools, the dissociated species form different molecular species via oxidation or reduction reactions. Oxidation reactions typically involve free oxygen atoms or hydroxyl radicals (.OH), and reduction reactions typically involve hydrogen atoms and electrons. The electrons typically come from sodium chloride in the water, which can be at a concentration of at least 0.10 molar (M). Ionized water can also serve as a source of electrons.

Still referring to FIG. 3, the particulate capture component is operatively configured to the second vaporization chamber 35 (or can be operatively configured to the second igniter 30, first vaporization chamber 25 or first igniter 20 depending on the presence or absence of the optional components) to permit one of many possible functions depending on the need. For example, the particulate capture component can be a condenser, muffler, air pollution control devices, including an ash capture component, ash scrubber component, air scrubber component, or some combination thereof. In some embodiments, the particulate capture component 40 is an air scrubber to collect any ash or other matter resulting from the ignition of the flowable solution. In other embodiments, the particulate capture component 40 is a condenser to collect any liquid remaining after first (and sometimes second) ignition of the flowable solution.

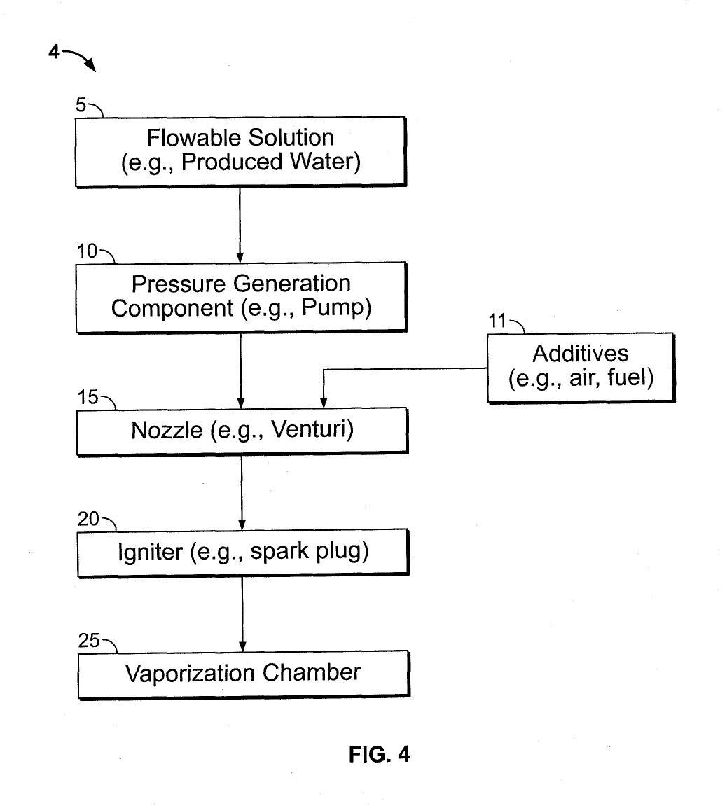

Referring to FIG. 4, in some embodiments the presently disclosed liquid vaporization system further comprises additives 11 that are incorporated with the flowable liquid at, prior to, or after the nozzle 15. Additives can include any number of materials, naturally occurring or otherwise, to enhance or reduce the ignition of the flowable solution. For example, in some embodiments an additive can be air, natural gas, methane, propane, butane, a hydrocarbon gas mixture, diesel or some combination thereof. The additives are incorporated into the liquid vaporization system using one or more flammable fuel lines coupled to the nozzle, upstream of the nozzle, or downstream of the nozzle so as to add turbulence or swirl to the controlled burn, and configured to deliver flammable fuels thereto. In an embodiment, the additive, e.g., flammable fuel, will mix with the flowable solution prior to the nozzle or at the nozzle and the mist created by the nozzle will comprise both the additive and the flowable solution. In another embodiment, one or more additives can be mixed with the flowable solution after the nozzle, for example, the additives can be injected directly into the igniter chamber or vaporization chamber. In this embodiment, the injection of the additives at the igniter or vaporization chamber can add swirl or turbulence to the burn and/or reaction thereby enhancing the controlled burn. A typical additive is flammable gas. Flammable gas is typically, but not necessarily, natural gas, which is mostly methane (CH₄).

In an embodiment, the liquid vaporization system includes at least two additives. For example, the first additive is natural gas (or other flammable hydrocarbon) and is delivered to the nozzle (or upstream of the nozzle) through a first flammable fuel line. The second additive is air and is delivered to the nozzle (or upstream of the nozzle) through a second flammable fuel line. The air, natural gas and flowable fuel are mixed at and pushed through the nozzle resulting in a spray (e.g., mist or aerosol) that comprises flowable solution, the natural gas and the air.

Embodiments of a liquid vaporization system include pulsed electric discharges or sparks generated in a spray of produced water combined with a flammable gas. The flammable gas consequently burns and the water is vaporized. Because a high temperature plasma can be created, both the water and the flammable gas can dissociate into other reactive species.

In an embodiment, air (or other additive) may also be added to the liquid vaporization system downstream of the nozzle, after the first or second igniter, into the first or second vaporization chamber to provide turbulence or additional mixing within the vaporization chamber and further enhance the controlled burn.

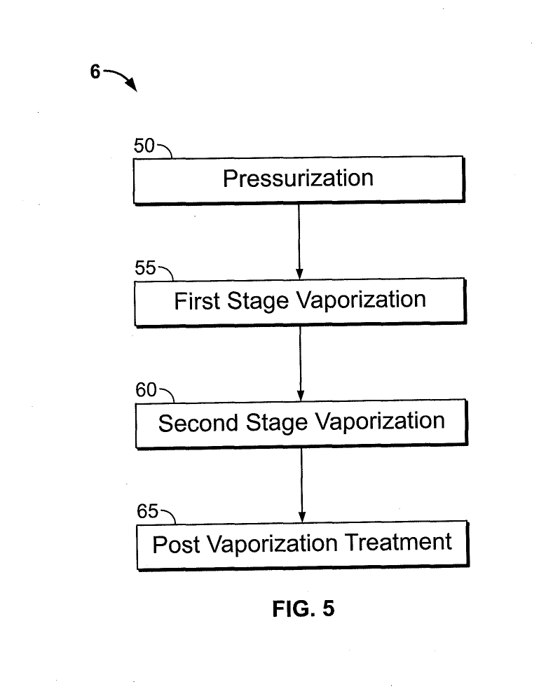

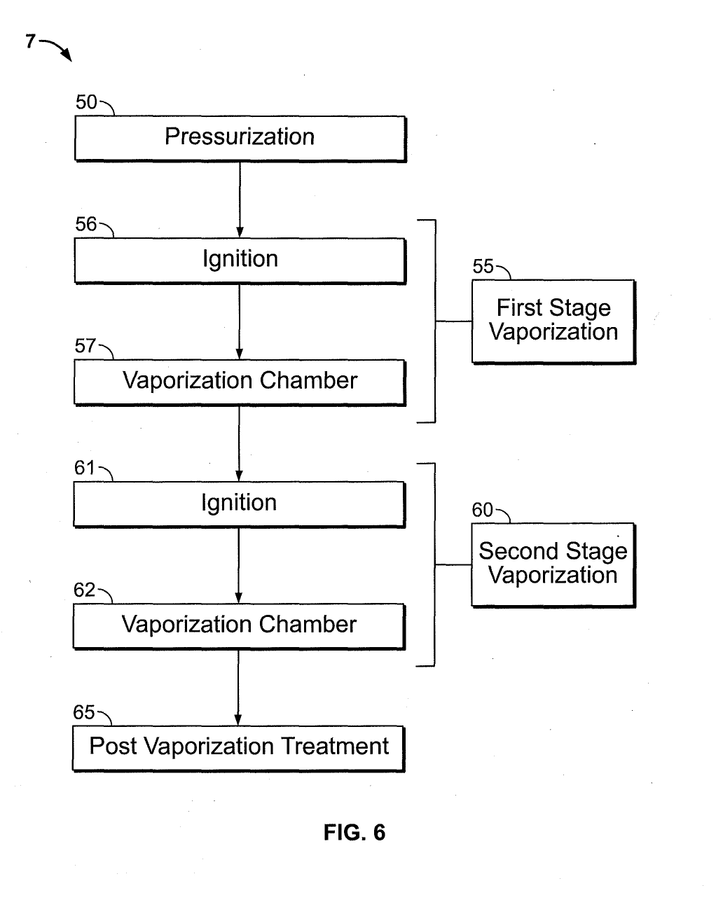

Referring now to FIG. 5 and FIG. 6, a method of the present disclosure includes pressurizing 50 a flowable solution, followed by first stage vaporization 55. Pressurization of the flowable solution is achieved by means discussed earlier in this specification.

In an embodiment, first stage vaporization 55 comprises delivering a flowable solution to a nozzle under pressure where the nozzle is configured to receive the flowable solution and convert the flowable solution into droplets, and a first igniter 56 is configured to ignite the droplets. In some embodiments, first stage vaporization 55 may further comprise delivering one or more additives to the nozzle, or upstream of the nozzle, under pressure in order to obtain a spray that comprises the flowable liquid in addition to the additives. In an exemplary embodiment, the additives include air delivered through a first fuel line and natural gas delivered through a second fuel line.

In some embodiments, first stage vaporization may further comprise delivering the flowable solution, air and natural gas to the nozzle and ignition source 56 wherein the controlled burn of the spray if further delivered to a vaporization chamber 57. The nozzle, igniter and vaporization chamber can take on any number of variations contemplated by this specification.

A method can further comprise delivering the product of the first stage vaporization 55 to a second stage vaporization 60. In certain embodiments, the controlled burn of the flowable solution (and any potential additives) within the first vaporization chamber 57 is then delivered to a second igniter 61 and in some embodiments a second vaporization chamber 62. A method can also additional comprise delivery of the controlled burn of the flowable solution (and any potential additives) following either the first 55 or second stage vaporization 60 to a post vaporization treatment 65. The post vaporization may comprise delivering the controlled burn, or byproducts therefrom, to a condenser or ash scrubber to retain byproducts of the process.

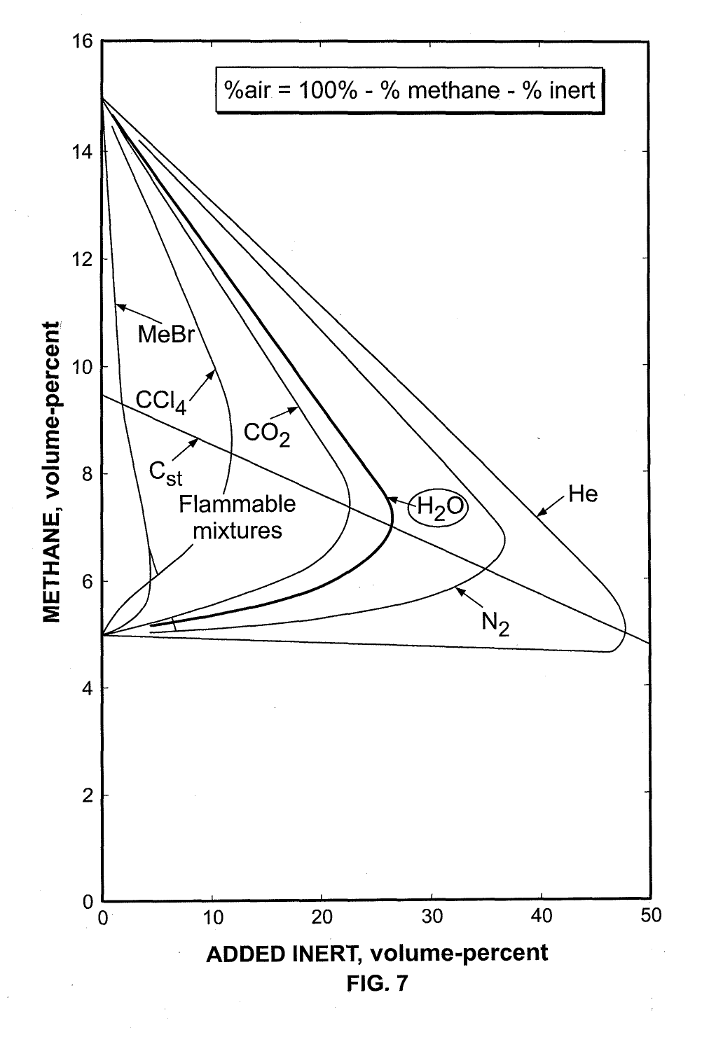

Referring now to FIG. 7 which discloses flammability limits for a single spark in air/methane/water. As indicated in FIG. 7, an air CH₄/H₂O (vapor) mixture can be ignited even if nearly 25% of the mixture is water vapor. Most of the research on this topic that has been performed over the past half century has been related to the practical applications of flame quenching, extinction of large fires, and the mitigation and suppression of explosions. However, by using continuous sparking, sustained or pulsed burning of gas can be maintained where densities of water exceed 25% by mass. Embodiments include water mass densities preferably greater than 20%, more preferably greater than 30%, still more preferably greater than 40%, and most preferably greater than 50%.

Other relevant quantities that have been measured over the years include minimum spark ignition energies in air, O₂, and mixtures thereof; minimum spark ignition quenching distances; maximum experimental safe gaps; and minimum auto ignition temperatures of combustible gases and gas mixtures.

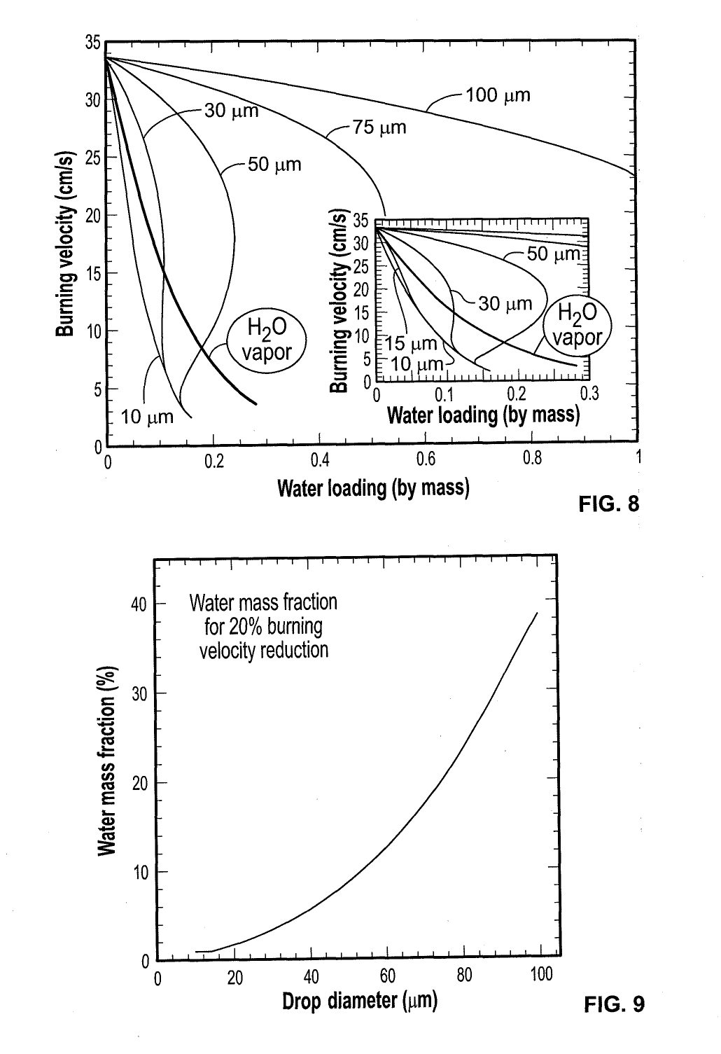

Results of measurements and calculations on water aerosol inhibition of premixed methane/air flames are illustrated in FIG. 8 and FIG. 9. FIG. 8 and FIG. 9 are based on graphs created by Robert Kee at the Colorado School of Mines.

FIG. 8 shows burning velocity as a function of initial water loading and droplet size. A water loading of 1.0 indicates an equal mass of water droplets and gas mixture in the unburned mixture. Initial droplet diameters range from 10 μm to 100 μm. The inset figure provides an expanded view of the low-loading region. From FIG. 8 we can see that water drop sizes less than about 20 μm are very effective in quenching the burn. As the drop size increases, larger mass loadings have a diminishing effect upon the burn velocity.

FIG. 9 shows the water mass fraction for a given drop diameter needed to reduce the burn velocity by 20%. Again, larger drop sizes are less effective at reducing burn velocity at a given water mass loading. It should be noted that these results were obtained for a single spark, not multiple sparks or a spark train, configuration.

### EXAMPLE 1

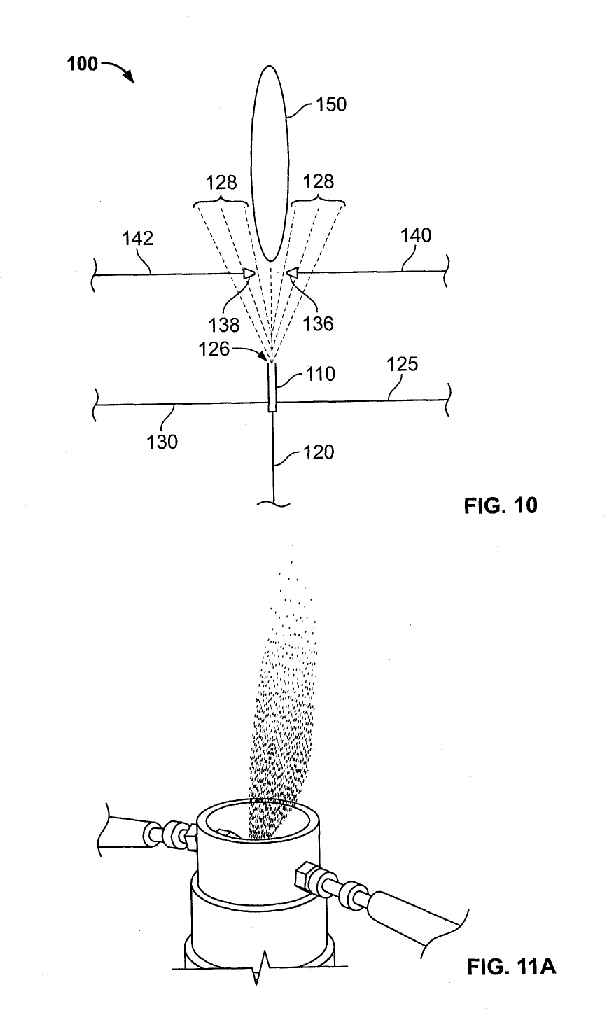

A liquid vaporization system 100 is illustrated in FIG. 10. The liquid vaporization system includes a nozzle 110 into which are fed a flowable solution line 120, a first fuel line (oxidant line) 125, and a second fuel line (gas line) 130. The flowable solution line 120 is a water line. The nozzle 110 is an off-the-shelf standard mixing nozzle. Water goes in the center and flammable gas goes in a separate inlet. The nozzle works via Venturi's Principle and produces a spray including an average droplet size that is a function of the water flow rate and the gas pressure, as shown in Table 2.

The second fuel line (gas line) 130 feeds flammable gas into the nozzle, where the flammable gas mixes with the oxidant introduced through the first fuel line (oxidant line) 125, and water (e.g., produced water or other flowable solution) from the flowable solution line 120. A resulting aqueous spray 128 is discharged out a nozzle orifice 126.

The oxidant is diatomic oxygen (O₂) (typically, but not necessarily), and the O₂ source is air (typically, but not necessarily). Accordingly, air is pumped through the first fuel line (oxidant line) to provide O₂ as the oxidant.

It should be noted that in some embodiments, the air may be supplemented with additional O₂ or other oxidant. Other oxidants include, but are not limited to, ozone and nitrous oxide. Variations include oxidant solutions or mixtures that combine oxidants with noble gasses or other inert gases instead of or in addition to air. Inert gases include, but are not limited to, molecular nitrogen (N₂) and carbon dioxide (CO₂).

The flammable gas is typically, but not necessarily, natural gas. Natural gas comprises mostly methane, with smaller amounts of other flammable gasses such as ethane (C₂H₆) and propane(C₃H₈). Natural gas can include small quantities of other hydrocarbons or flammable molecules as well. Other flammable gasses are also contemplated.

Still referring to FIG. 10, the liquid vaporization system 100 further comprises a first igniter consisting of a first electrode 136 and second electrode 138. Both first and second electrodes are tungsten electrodes. A high voltage line 140 delivers relatively high voltage to the first electrode 136 and a low voltage line 142 maintains the second electrode 138 at a lower voltage compared to the first electrode 136. The second electrode 138 is typically, but not necessarily, at ground potential.

Table 2 shows droplet size as functions of gas pressure and water flow rate for the mixing nozzle 110.

TABLE 2
Technical Data
The droplet size (mass median diameter) and distribution depends on geometrical parameters
(mainly the orifice diameter and shape), the properties of the fluids (mainly the liquid prop-
erties) and the working conditions (liquid flow rate and gas pressure drop through the orifice.)
The following tables illustrate varying outputs of certain standard nozzles. Additional
output variations are achieved with different parameters such as liquid viscosity, gas
density, nozzle geometry and materials.

| Orifice Size: | 400 mm | | | | | |
|---|---|---|---|---|---|---|
| Liquid: | Water @ 15° C. | AVERAGE DROPLET SIZE (mm) | | | | |
| Gas: | Air @ 15° C. | Gass Pressure | | | | |
| | | 0.69 Bar | 1.03 Bar | 1.38 Bar | 1.72 Bar | 2.07 Bar |
| | | (10 psi) | (15 psi) | (20 psi) | (25 psi) | (30 psi) |
| Liquid | 5 ml/min | 20 | 15 | 12 | 10 | 9 |
| Flow | 10 ml/min | 35 | 24 | 20 | 17 | 14 |
| | 15 ml/min | 52 | 36 | 28 | 23 | 20 |
| | 20 ml/min | 72 | 49 | 38 | 31 | 26 |
| | 25 ml/min | 96 | 64 | 49 | 39 | 33 |

For the experiments represented in Table 2, air is delivered to the nozzle 110 through the first fuel line (oxidant line) 125 at approximately 0.20 liters per minute, and propane is delivered through the second fuel line (gas line) 130 at between approximately 0.50 and 0.75 liters per minute. The propane, air, and water are co-mixed in the nozzle 110 and are discharged in a spray 128 through the nozzle orifice 126. At least a portion of the spray is delivered between the first and second electrodes 136, 138. The electrodes are driven by a capacitive ignition module and high voltage coil. A spark is thus produced between the electrodes. Sparking frequency across the first and second electrodes 136, 138 is modulated using a signal generator driving the ignition module. Sparking frequency is (typically, but not necessarily) in a range of 800-900 Hz.

Suitable variations to the first and second electrodes 136, 138 include pulsed power sources such as high-voltage capacitors switched with spark gaps or solid state elements, high voltage transformer-primary switched devices, high voltage DC power supplies, RF power supplies, or repetitively-pulsed magnetic-pulse compressor high voltage pulse generators.

As shown in Table 2, readily maintained flammable gas pressures and water flow rates result in relative large droplet sizes that minimize decrease in flame velocity. By minimizing the decrease in flame velocity, sustained or pulsed burning is facilitated.

### EXAMPLE 2

Still referring to FIG. 10, in a method of using a liquid vaporization system 100, water is delivered to the nozzle 110 through the flowable solution line 120 at about 180 mL per minute, and propane is delivered through the second fuel line (gas line) 130 at about 1000 mL per minute. Air is delivered through the first fuel line (oxidant line) 125 at about 200 mL per minute, and the air/water/flammable gas mixture is discharged as a spray 128 from the nozzle orifice 126. The water mass flow rate can be greater than 100 times the flammable gas mass flow rate.

The propane, air, and water are co-mixed in the nozzle 110 and are discharged in a spray 128 through the nozzle orifice 126. At least a portion of the spray is delivered between the first and second electrodes 136, 138. The Electrodes are driven by a capacitive ignition module and high voltage coil. A spark is thus produced between the electrodes. Sparking frequency across the first and second electrodes 136, 138 is modulated using a signal generator driving the ignition module. Sparking frequency, also referred to as pulsing frequency is typically in the range of 800-900 Hz. A stable flame 150 is maintained, and the water delivered through the flowable solution line 120 is vaporized. The stable flame 150 is maintained through continuous burning or by being reignited 800-900 times per second.

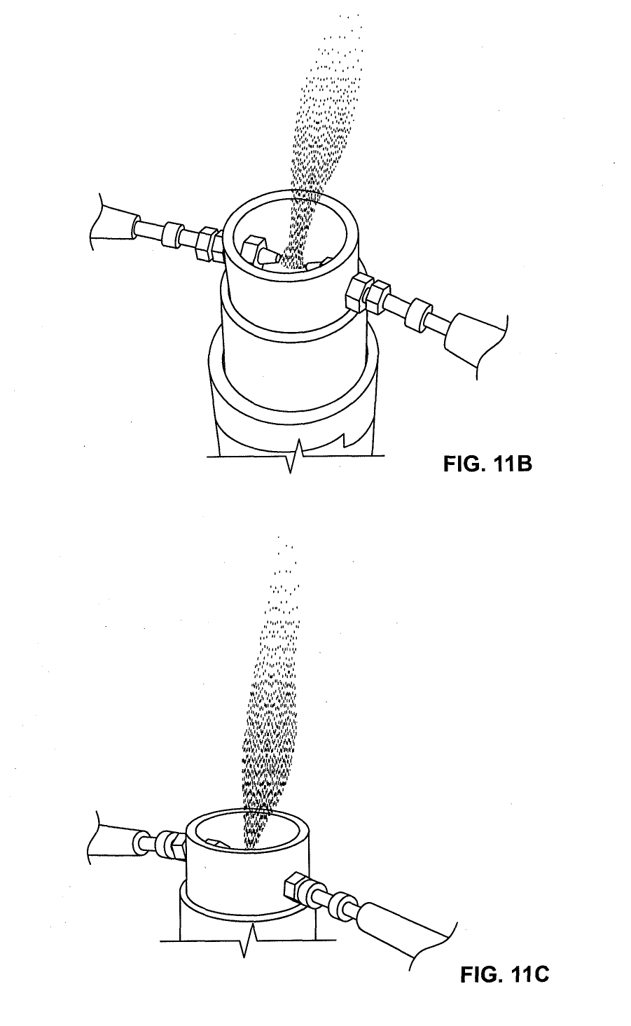

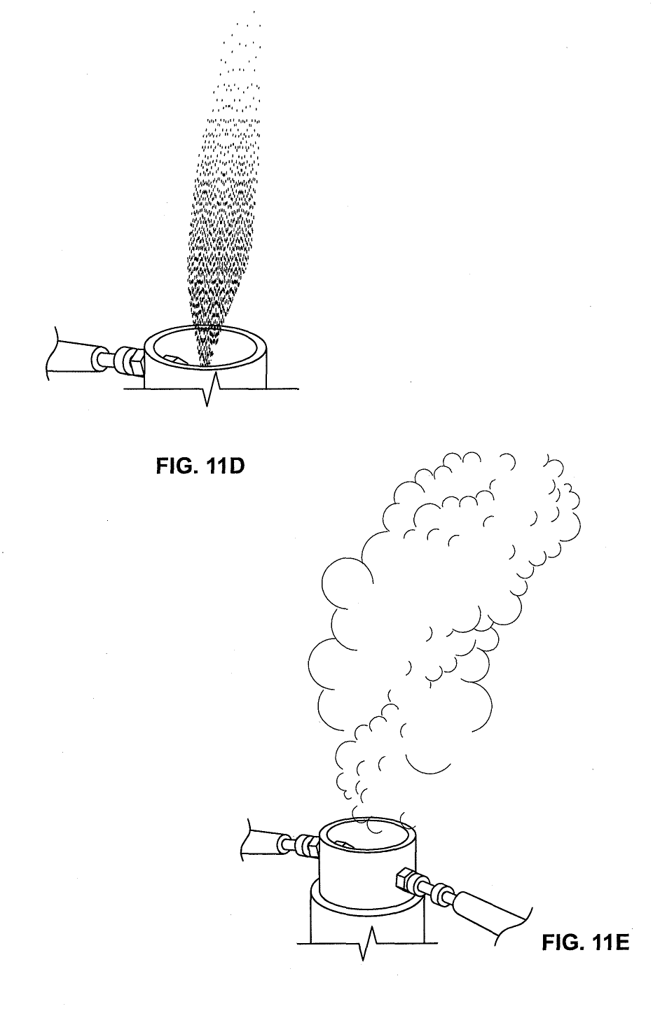

Referring now to FIGS. 11A-E, which discloses flames generated by the method of using the liquid vaporization system. A blue flame is produce by an air/propane/gas mixture ignited by a spark across electrodes driven by a MSD capacitive discharge ignition system (see, e.g., FIG. 11A). Yellow flames have air, propane, and tap water mist flowing (see, e.g., FIG. 11B-D). The yellow color results from atomic sodium light emission from salt contained in the water. FIG. 11E shows an aqueous spray in the absence of spark.

Embodiments of liquid vaporization systems are readily replicated in parallel. The above described method and system employs a simple point-to-point tungsten electrode configuration; however, the described examples can be replicated in parallel.

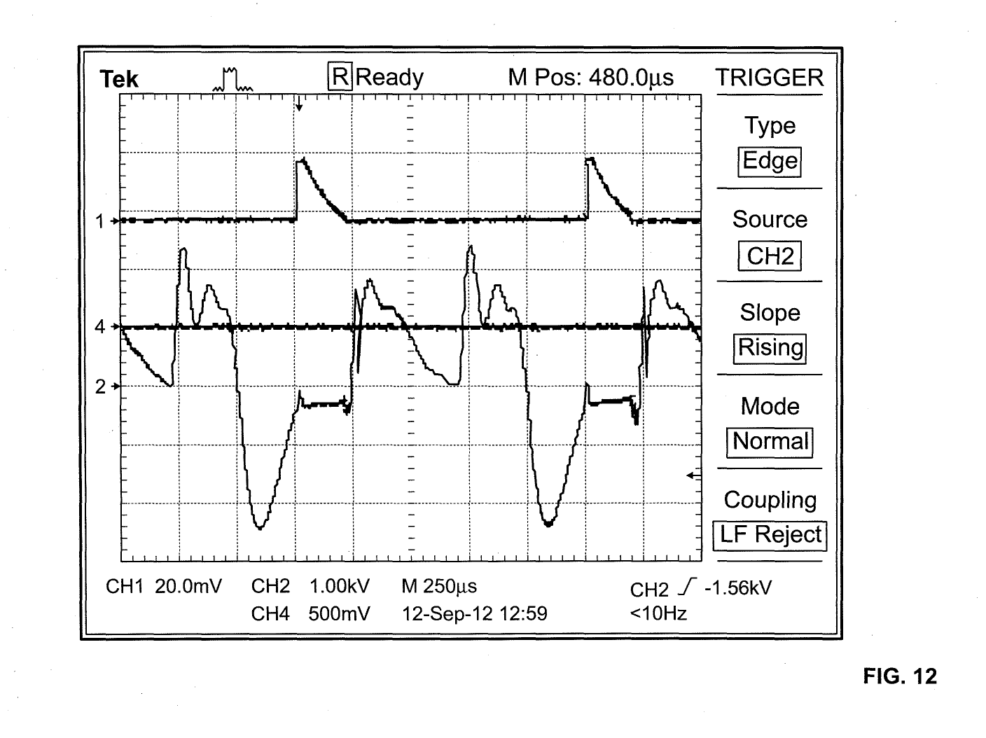

Referring now to FIG. 12 which discloses a oscilloscope traces of the voltage (Channel 2) and the current (Channel 1, where 1 A=0.1 V) for the liquid vaporization system during operation. The voltage and current pulses are very stable and repeatable. The time scale is 1/4 msec per division so that the frequency is approximately 1/(5/4)×1000 Hz=800 Hz. The peak current is about 2 A and the peak voltage is about 3.4 kV. The reactive power losses are very small.

Alternative embodiments of liquid vaporization devices according to the present invention, including various nozzle and electrode geometries, include gliding arc and ladder or antennae electrodes, are contemplated.

### EXAMPLE 3

Pretreatment of the flowable solution prior to ignition is an optional component or step in the present disclosure and is not necessary; however, in some embodiments it can be beneficial. In this example, water prior to use in oil and natural gas production operations (“inlet”) was compared to waste water from the oil and natural gas production operations (“off case”) and further compared to waste water that was subjected to pretreatment (“outlet”). The waste water (“off case”) from the oil and natural gas production operations was pretreated with an oil/water separator and chemicals to reduce the contaminants (“outlet”). For example, compare the “off case” column with the “outlet” column.

| | | Off | | |
|---|---|---|---|---|
| Analyses | Inlet | Case | Outlet | Units |
| General Parameters | | | | |
| Alkalinity as CaCO3 | 3000 | 5000 | 100 | mg/L |
| Total Hardness as CaCO3 | 100 | 200 | 100 | mg/L |
| Major Ions | | | | |
| Ammonia | 8 | 15 | 1 | mg/L |
| Calcium | 60 | 120 | 60 | mg/L |
| Chloride | 3300 | 5000 | 230 | mg/L |
| Fluoride | 15 | 15 | 2 | mg/L |
| Magnesium | 40 | 80 | 40 | mg/L |
| Nitrate | 3 | 3 | 3 | mg/L |
| Potassium | 25 | 25 | 25 | mg/L |
| Sodium | 3000 | 5000 | 75 | mg/L |
| Sulfate | 15 | 15 | 15 | mg/L |
| Physical Properties | | | | |
| Conductivity | 11000 | 14000 | 300 | uS/cm |
| pH | 7.5 | 8.5 | 6.5-8.5 | s.u. |
| Total Dissolved Solids | 7500 | 10000 | 250 | mg/L |
| (TDS) | | | | |
| Total Suspended Solids | 50 | 500 | 5 | mg/L |
| (TSS) | | | | |
| Turbidity | 35 | 350 | 5 | NTU |
| Temperature | <100 | <100 | <100 | F. |
| Pressure | 20 | 20 | Atmospheric | psi |
| TOC | 300 | 600 | 10 | mg/L |
| COD | 1200 | 2400 | 25 | mg/L |
| BOD | 350 | 700 | 25 | mg/L |
| Total Metals | | | | |
| Selenium | <0.5 | <0.5 | <0.5 | ug/L |
| Iron | 2000 | 4000 | <0.5 | ug/L |
| Barium | 10 | 20 | 2 | mg/L |
| Dissolved Metals | | | | |
| Aluminum | 400 | 400 | 50 | ug/L |
| Arsenic | <2.5 | <2.5 | <2.5 | ug/L |
| Beryllium | <1 | <1 | <1 | ug/L |
| Boron | 15000 | 30000 | 1000 | ug/L |
| Cadmium | <0.08 | <0.08 | <0.08 | ug/L |
| Chromium | <0.5 | <0.5 | <0.5 | ug/L |
| Copper | 2.5 | 3.5 | 2.5 | ug/L |
| Iron | 130 | 250 | 130 | ug/L |
| Lead | 15 | 15 | <0.1 | ug/L |
| Manganese | 50 | 100 | 50 | ug/L |
| Mercury | <0.2 | <0.2 | <0.2 | ug/L |
| Nickel | <2.5 | <2.5 | <2.5 | ug/L |
| Silica | 90000 | 200000 | 90000 | ug/L |
| Silver | <0.5 | <0.5 | <0.5 | ug/L |
| Strontium | <0.5 | <0.5 | <0.5 | ug/L |
| Thallium | <0.1 | <0.1 | <0.1 | ug/L |
| Zinc | 1000 | 2000 | 100 | ug/L |
| Hydocarbons | | | | |
| TPH | 10 | 50 | 1 | mg/L |
| Benzene | 15 | 75 | 0.0022 | mg/L |
| Toluene | 30 | 150 | 1 | mg/L |
| Ethyl Benzene | 2 | 10 | 0.15 | mg/L |
| Xylene | 15 | 75 | 10 | mg/L |
| GRO | 250 | 1250 | 5 | mg/L |
| DRO | 75 | 375 | 5 | mg/L |
| Methanol | 150 | 300 | 1 | mg/L |

This treated water (“outlet”) is ready for pressurization and direction to a nozzle and a subsequent igniter. Notably, the untreated water (“off case”) can also be pressurized and directed to a nozzle and a subsequent igniter. In fact, the untreated water was subjected to a liquid vaporization system embodiment of the present disclosure.

### EXAMPLE 4

In this example, raw water (flowable solution) was pre-treated with an oil/water separator and chemicals to reduce some of the contaminants, including the total suspended solids, the guar and the polysaccharide. The analysis of the untreated water (raw water) and the treated water is below.

| | Raw | | Treated | |
|---|---|---|---|---|
| Analyte | Water | | Water | |
| pH | 7.44 | | 6.64 | |
| Color | Black | | Clear | |
| Calcium | 237 | mg/l | 247 | mg/l |
| Magnesium | 13 | mg/l | 13 | mg/l |
| Sodium | 3,376 | mg/l | 2,695 | mg/l |
| Potassium | 25 | mg/l | 24 | mg/l |
| Chlorides | 4,500 | mg/l | 3,700 | mg/l |
| Sulfates | 150 | mg/l | 150 | mg/l |
| Carbonate | 2.1 | mg/l | <1.0 | mg/l |
| Bicarbonate | 450 | mg/l | 50.5 | mg/l |
| Total Dissolved | 8,200 | mg/l | 8,660 | mg/l |
| Solids | | | | |
| Total Suspended | 360 | mg/l | <10 | mg/l |
| Solids | | | | |
| Oil and Grease | >10,000 | mg/l | <2.0 | mg/l |
| Total Iron | 72.4 | mg/l | 44.8 | mg/l |
| Guar, Polysaccharide | 234 | mg/l | <0.2 | mg/l |

This treated water is ready for pressurization and direction to a nozzle and a subsequent igniter. Notably, the untreated water can also be pressurized and directed to a nozzle and a subsequent igniter.

### ADDITIONAL EXAMPLES

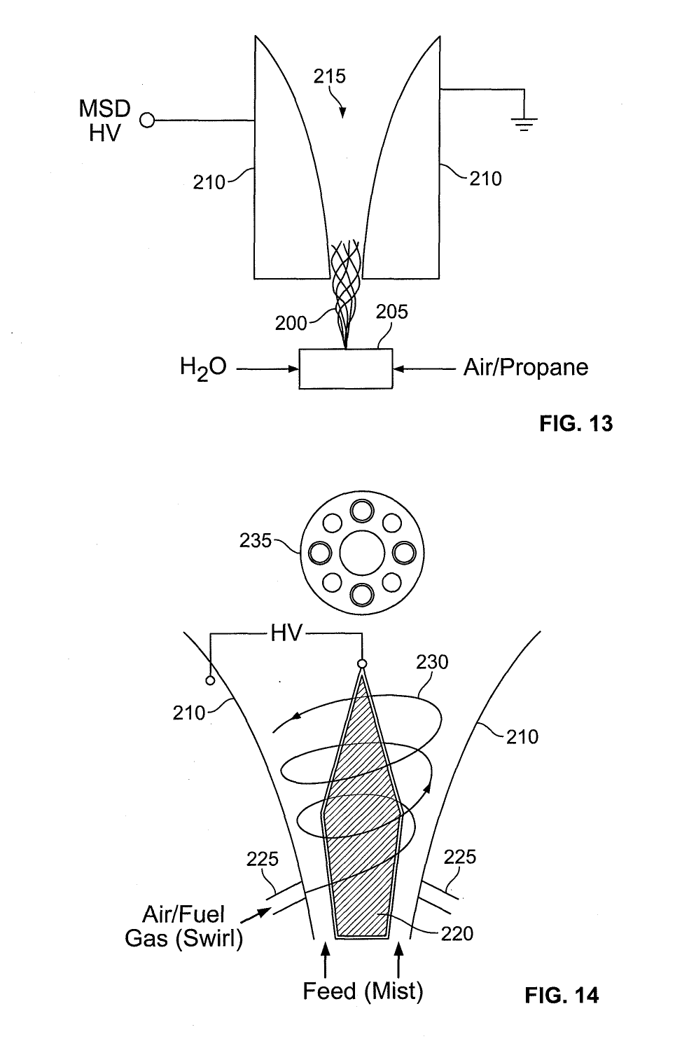

Referring now to FIG. 13 which discloses an embodiment of a gliding arc igniter with a nozzle 205. In the embodiment disclosed in FIG. 13, water, air and propane are mixed at the nozzle 205 having a 500 μm opening (orifice). The discharge spray 200 is directed upwards toward the igniter which in this embodiment is a high voltage MSD capacitive discharge with a gap 215 between plates 210 at the spray entrance of roughly 4-5 mm. The igniter initiates a controlled burn of the spray.

Referring now to FIG. 14 which discloses another embodiment of a 3-D gliding arc igniter of the liquid vaporization system. A top view of a nozzle 235 is disclosed where the discharge orifice of the nozzle can rotate around its central axis to create a swirling effect. While not shown, the discharge orifice of the nozzle is directed up toward and between the electrode plates 210 of the 3-D glid-arc igniter. In this embodiment the flowable liquid is driven under pressure into the nozzle to create a spray (mist) 220 that is directed upwards between the electrode plates 210 of the 3-D glid-arc igniter. Instead of the additives, e.g., air and flammable gas, mixing with the flowable liquid upstream or at of the nozzle, the additives (e.g., air and/or natural gas) are directed between the electrode plates 225 (downstream or after the nozzle) where it mixes with the spray of flowable liquid and further enhances the swirling effect 230 of the spray, in addition to adding turbulence and agitation to the controlled burn.

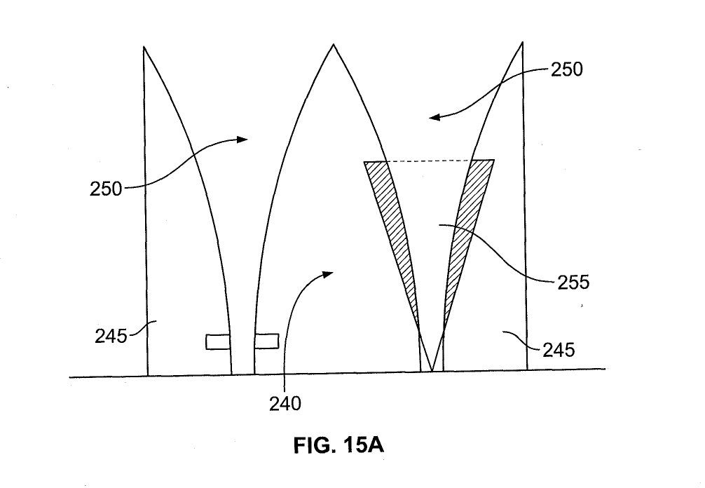

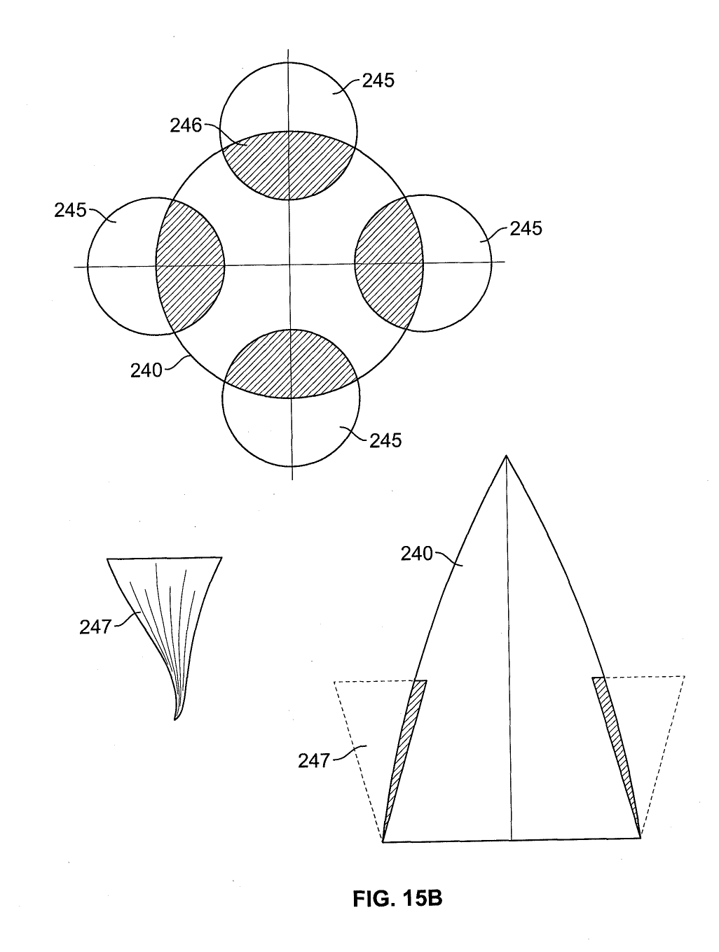

Referring now to FIG. 15A, which discloses a side view of a multi-electrode glid-arc embodiment of the igniter. In this embodiment, four electrode plates 245 are spaced at 90 degrees around a center cone 240 (carrot). This orientation creates four igniters within the embodiment as each electrode plate 245 carries an electrode and is capable of creating a spark (or arc) between the electrode plate and the center cone 240. Therefore, sparks (or arcs) can occur between the gap 250 created by each of the four electrode plates 245 and the center cone 240. This embodiment can utilize four nozzles, one beneath each cap created by an electrode plate 245 and the center cone 240. Each of the four nozzles (not pictured) directs a spray 255 of flowable solution (or flowable solution in combination with one or more additives) upwards into the roughly 5 mm gap created between the base of each electrode plate 245 with the center cone 240. The spray is ignited by the sparks and/or arcs created between each electrode plate 245 and the center cone 240.

Referring now to FIG. 15B, which discloses a top view of the embodiment discussed in FIG. 15A and a partial side view of the same embodiment. Looking at the top of this embodiment, the center cone 240 is surrounded by four electrode plates 245, spaced approximately 90 degrees around the center cone 240 with a three inch diameter. The shaded region 246 at the space between each electrode plate 245 and center cone 240 represents the 60 degree cone spray pattern of the spray discharged from the nozzles (not pictured). Still referring to FIG. 15B, a side view discloses (without showing the electrode plates) the center cone 240 (carrot) and the spray patterns 247 from the nozzles that sit just beneath this embodiment of the igniter.

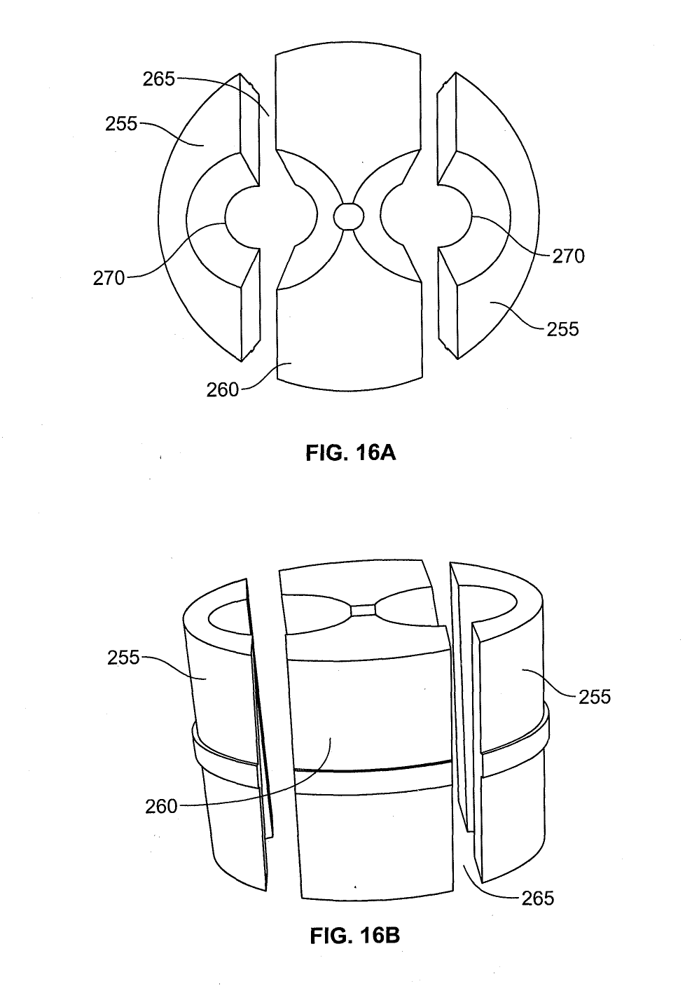

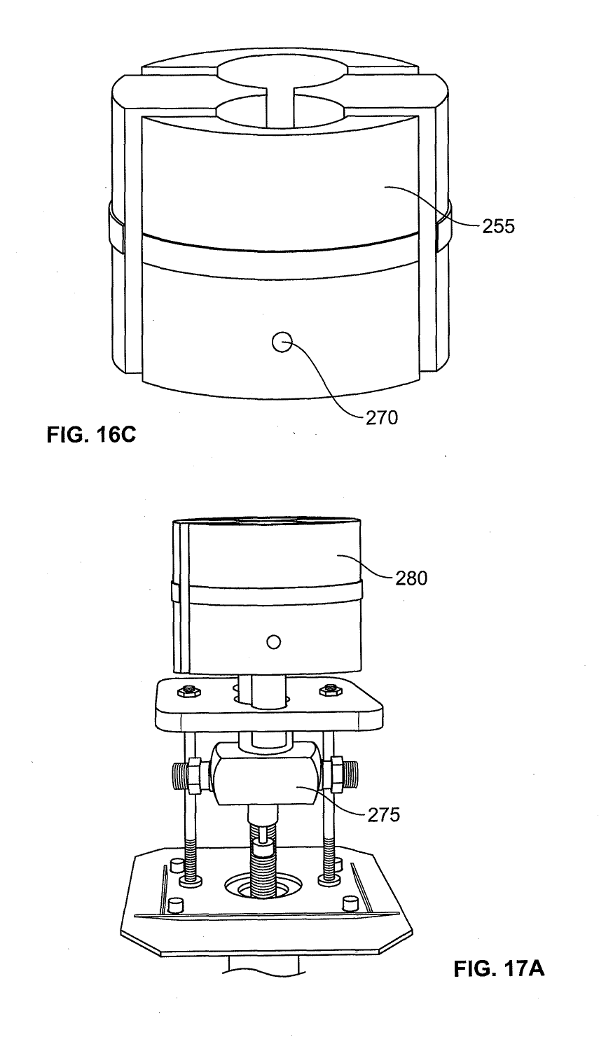

Referring now to FIG. 16A, which discloses a top view of a cavetron-plasmatron 3-D glid-are igniter embodiment that may be used with the systems, devices and methods presently disclosed. As shown in FIG. 16A, a top view of the 3-D glid-arc discloses two 60 degree cone-like cavities 270 created by outer electrode plates 255 and a center plate 260. Two nozzles (not pictured) sit beneath the cavetron-plasmatron 3-D glid-arc igniter, one nozzle beneath each cone cavity 270. Gaps 265 exist between each outer electrode plate 255 and the center plate 260. Each nozzle projects a spray up into the narrowest portion of each 60 degree cone cavity 270 (at the viewer in this view) which is ignited by sparks or an arc created between the gaps 265 between each outer electrode plate and the center plate 260. As show in FIG. 16B, a side view of the 3-D glid-arc discloses the gap 265 between the outer electrode plates 255 and the center plate 260. As shown in FIG. 16C, a side view (rotated 90 degrees from FIG. 16B) discloses the igniter electrode hole 270 for placement of the electrode (not pictured) in the outer electrode plate 255.

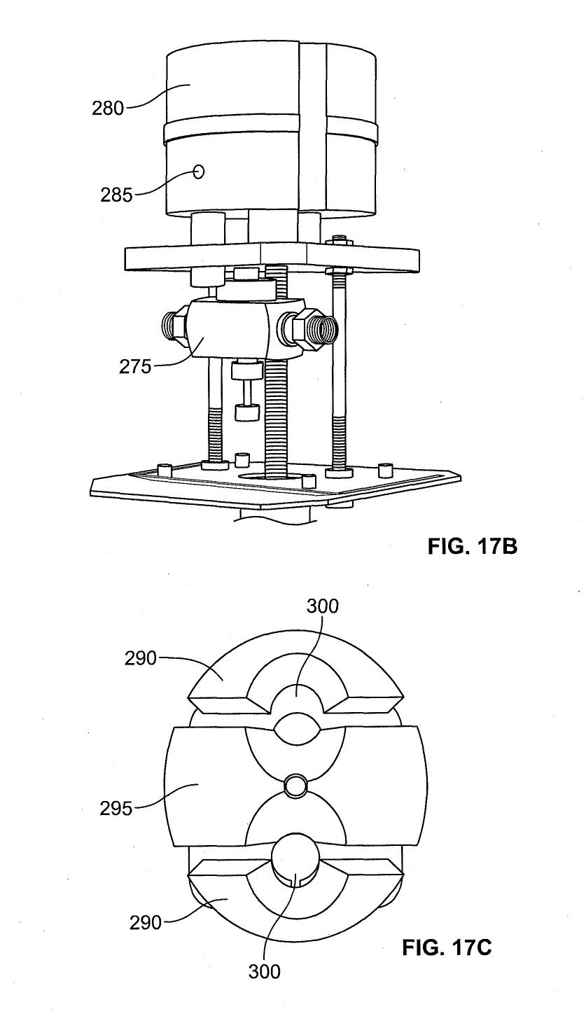

Referring now to FIG. 17A, which discloses the cavetron-plasmatron 3-D glid-arc igniter 280 embodiment of the present disclosure sitting above a nozzle 275 embodiment of the present disclosure. The nozzle 275 is configured to direct two streams of spray up into the base of each cone in the igniter 280 where each stream will be ignited by sparks or arcs created between the outer electrode plates 290 and the center plate 295. FIG. 17B discloses a side view of the cavetron-plasmatron 3-D glid-arc igniter 280 embodiment coupled to a nozzle 275. An electrode hole 285 for placement of an electrode (not pictured) in the outer electrode plate 290 is also shown. FIG. 17C discloses a top view of the cavetron-plasmatron 3-D glid-arc igniter where the viewer is looking down the 60 degree cone-like cavity created between the outer electrode plates 290 and the center plate 295.

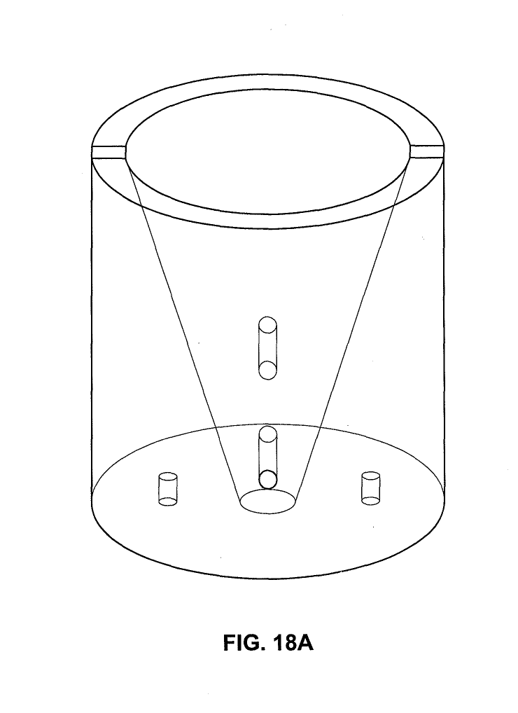

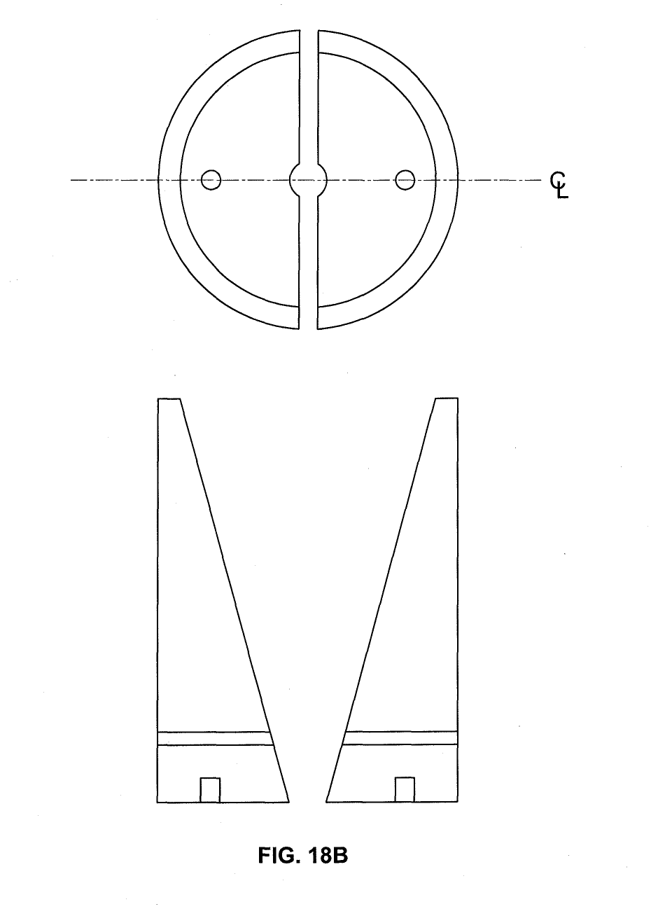

Referring now to FIG. 18A, which discloses a graphite cavitron 3-D glid-arc plasma igniter embodiment of the present disclosure. In this embodiment, the graphite igniter has a roughly 3 inch diameter with a 60 degree cone-like cavity in between the two electrode plates. The two electrode plates are separated by approximately an ¼inch gap. The base of the igniter (where the 60 degree cone-like cavity reaches its narrowest) is roughly a ½inch diameter hole where a nozzle (not pictured) will project a spray up into the igniter. In this embodiment, each electrode plate has an electrode placement hole proximal to the base of the igniter.

FIG. 18B discloses top view of the embodiment referred to in FIG. 18A. FIG. 18B further discloses a side view (rotated 90 degrees from the view disclosed in FIG. 18A) of the embodiment referred to in FIG. 18A. The 60 degree cone-like cavity is visible between the two electrode plates. The nozzle (not pictured) will project a spray up into the ½inch opening of the cone-like cavity and become ignited by the sparks or arcs created between the two electrode plates.

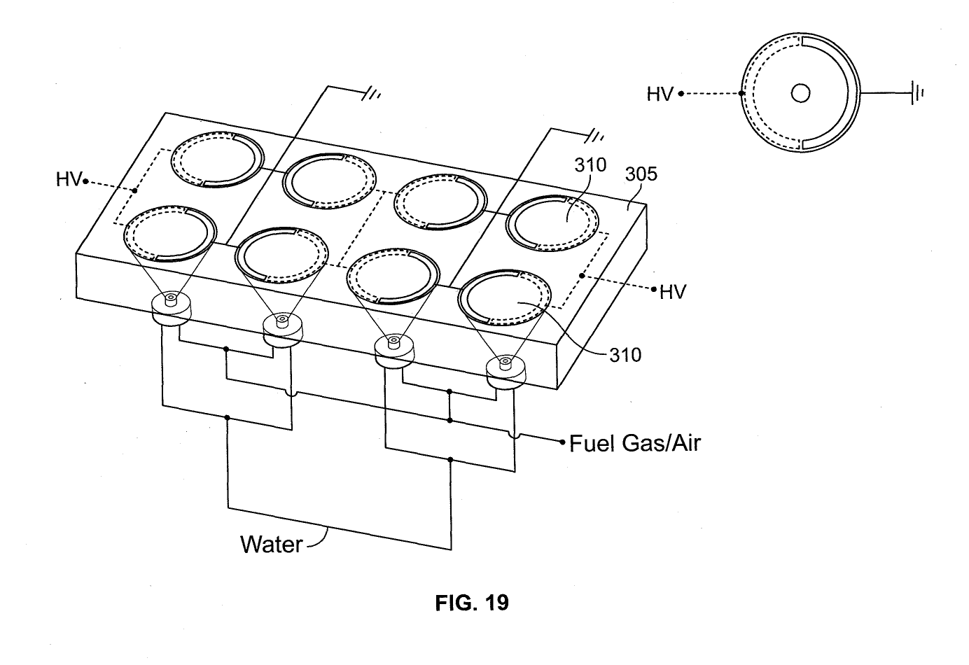

Referring now to FIG. 19, which discloses a modular cavitron chessboard. In this embodiment, eight igniters 310 are placed within a ceramic block 305. Below each igniter is a nozzle which is capable of mixing flowable solution with one or more additives (e.g., natural gas and air) and creating a spray that projects up into each individual igniter for ignition by sparks or arcs created at the base of each individual igniter.

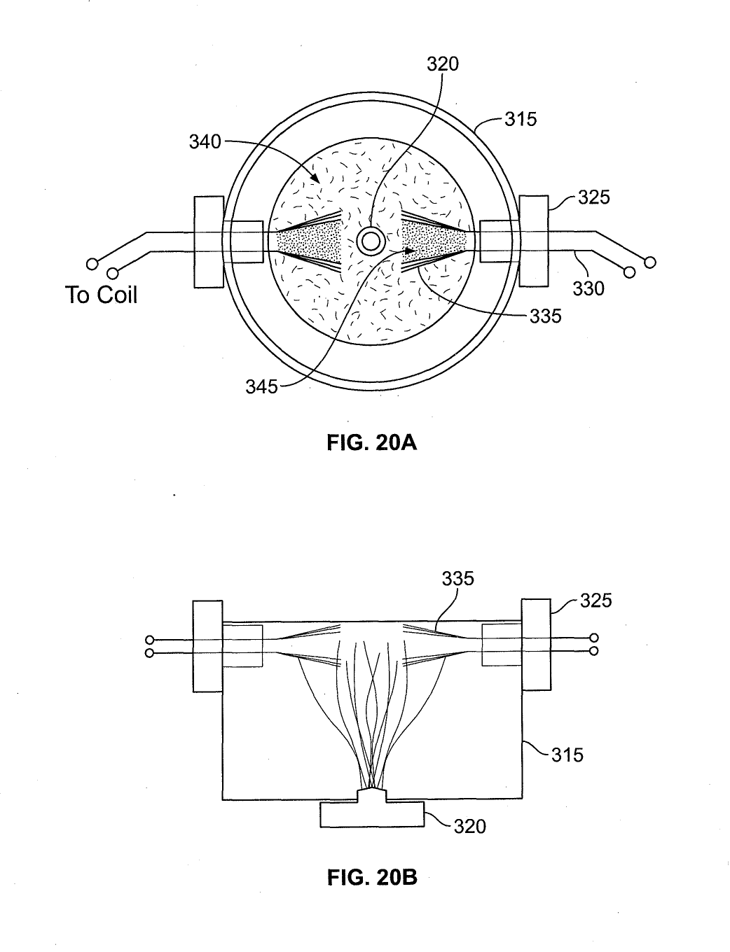

Referring now to FIG. 20A and FIG. 20B, which disclose an igniter 335 embodiment, nozzle 320 embodiment and vaporization chamber 315 embodiment of the present invention. In this embodiment, the igniter 335 is similar to a rail plug (U.S. Pat. No. 5,076,223) previously known. A vaporization chamber 315 encloses the igniter 335. A nozzle 320 injects an atomized mixture 340 of flowable solution (which may or may not include additional additives) into the vaporization chamber 315. The igniter 335 is within the vaporization chamber 315. When the atomized mixture 340 enters the vaporization chamber 315 it is ignited by the igniter 335 which generates a plasma 345 and ignites the atomized mixture 340 to create a controlled burn.

### Alternative Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

1. A liquid vaporization device comprising:
a pressure generation component;
a nozzle;
a first igniter in proximity to the nozzle; and
a flowable solution line;
the pressure generation component configured to pump flowable solution to the nozzle;
the flowable solution line coupled to the pressure generation component and the nozzle, and configured to deliver the flowable solution to the nozzle;
the nozzle configured to receive the flowable solution and convert the flowable solution into droplets; and
the first igniter configured to ignite the droplets.

2. The liquid vaporization device of claim 1 further comprising:
a first vaporization chamber, the vaporization chamber configured proximal to the igniter.

3. The liquid vaporization device of claim 1 further comprising:
a second igniter; and
a second vaporization chamber;
the second igniter subsequent to the first igniter and configured to ignite droplets remaining after passing the first igniter, and
the second vaporization chamber configured proximal to the second igniter.

4. The liquid vaporization device of claim 1 further comprising:
a particulate capture component.

5. The liquid vaporization device of claim 1 further comprising:
one or more flammable fuel lines coupled to the nozzle and configured to a flammable fuels thereto.

6. The liquid vaporization device of claim 1 further comprising:
an air line coupled to the nozzle and configured to deliver air thereto.

7. The liquid vaporization device of claim 1 further comprising:
a pretreatment component upstream of the nozzle and configured to modify the flowable solution.

8. The liquid vaporization device of claim 7, wherein the pretreatment component is an oil/water separator, a gravity pond, a produced water pit, a filter, storage vessel, dilution system or some combination thereof.

9. The liquid vaporization device of claim 4, wherein the particulate capture component is a condenser, muffler, air pollution control device, ash capture component, ash scrubber, air scrubber or some combination thereof.

10. The liquid vaporization device of claim 1 wherein the pressure generation component is a displacement pump, gravity pump, or some combination thereof.

11. The liquid vaporization device of claim 1 wherein the flowable solution is produced water, flowback water, leach field water, grey water, brown water, tar sand, mine waste water, storm drain water, or some combination thereof.

12. The liquid vaporization device of claim 1 wherein the nozzle is an atomizing nozzle, spray nozzle, mixing nozzle, cavitation nozzle, venturi nozzle, plasmatron nozzle, coanda nozzle, swirl nozzle, or some combination thereof.

13. The liquid vaporization device of claim 1 wherein the first igniter is a spark plug, plasma torch, microwave, radio frequency powered electrode, electronic ignition system, dialectic barrier discharge system, heated filament, rail plug, or some combination thereof.

14. The liquid vaporization device of claim 2 wherein the first vaporization chamber is configured to reduce sound or heat generated by the first igniter.

15. The liquid vaporization device of claim 3 wherein the second igniter is a spark plug, plasma torch, microwave, radio frequency powered electrode, electronic ignition system, dialectic barrier discharge system, heated filament, rail plug, or some combination thereof.

16. The liquid vaporization device of claim 3 wherein the second vaporization chamber is configured to reduce sound or heat generated by the second igniter and increase resonance time of the controlled burn.

17. The liquid vaporization device of wherein the flammable fuel is natural gas, methane, propane, butane, a hydrocarbon gas mixture, diesel or some combination thereof.

18. A liquid vaporization device comprising:
multiple electrodes configured to deliver sparks or continuous arcs therebetween at a rate of between 100 Hz and 100,000 Hz;
a mixing nozzle;
a flammable fuel line coupled to the mixing nozzle and configured to deliver a flammable gas thereto;
a water line coupled to the mixing nozzle and configured to deliver an aqueous composition thereto;
wherein:
the mixing nozzle is configured to deliver a spray between two of the multiple electrodes, the spray comprising water droplets and the flammable gas.

19. A method of vaporizing produced water containing concentrations of total dissolved solids, dissolved hydrocarbons, and inorganic salts, the method comprising:
delivering produced water through the water line;
delivering natural gas through the flammable fuel line;
generating a gas-water combination by co-mixing the produced water and the natural gas in the nozzle and delivering a spray between two or more electrodes, the spray comprising the produced water and the natural gas;
producing sparks or continuous arcs between the two or more electrodes at a rate between 500 Hz and 5000 Hz; and
vaporizing the produced water.

20. The method of claim 19, wherein the gas-water combination is greater than 25% by mass water.

21. The method of claim 20, further comprising generating a sustained flame proximate the two of the multiple electrodes for a time interval of at least 10 seconds, the sustained flame resulting from the natural gas and the sparks.

22. A liquid wastewater vaporization system adapted to vaporize produced water containing concentrations of total dissolved solids, dissolved hydrocarbons, and inorganic salts, the device comprising:
a produced water source providing the produced water;
a fuel source providing gaseous fuel;
an oxygen source providing oxygen;
a pressure generation component;
a nozzle;
a first igniter adjacent to the nozzle; and
the pressure generation component configured to deliver a mixture of the gaseous fuel, oxygen, and produced water under pressure to the nozzle;
the nozzle configured to receive the mixture and to convert the mixture into droplets; and
the first igniter configured to ignite the droplets.
